(19) United States
(12) Patent Application Publication
(10) Pub. No.: US 2017/0116800 A1
(43) Pub. Date: Apr. 27, 2017

(54) KEYLESS PASSWORD DEVICE OF LOCKING DOORS OF A VEHICLE WITHIN A SHORT DISTANCE AND METHOD OF LOCKING/UNLOCKING A VEHICLE

(71) Applicant: LEAUTO INTELLIGENT TECHNOLOGY (BEIJING) CO., LTD, Chaoyang District Beijing (CN)

(72) Inventors: Wei Lin, Chaoyang District Beijing (CN); Kunsheng Chen, Chaoyang District Beijing (CN); Dan Li, Chaoyang District Beijing (CN); Peng Liu, Chaoyang District Beijing (CN); Yong Xu, Chaoyang District Beijing (CN); Wenrui Li, Chaoyang District Beijing (CN); Yu Zou, Chaoyang District Beijing (CN)

(21) Appl. No.: 14/978,178

(22) Filed: Dec. 22, 2015

(30) Foreign Application Priority Data
Oct. 21, 2015 (CN) 2015106895768

(51) Int. Cl. G07C 9/00; B60R 25/01

(52) U.S. Cl. CPC G07C 9/00142; B60R 25/01

(57) ABSTRACT

The present disclosure provides a keyless password device of locking doors of a vehicle within a short distance, a vehicle, a vehicle system and a method of unlocking/locking a vehicle. Wherein, the device comprises: a password keyboard, a signal processing module, an overall control module, and a door-lock driving module. The present disclosure will process an analog signal corresponding to at least one key pressed by a user, and after obtaining key information corresponding to the at least one key, the present disclosure controls unlocking/locking of a door lock of the vehicle according to the key information, achieving that the user does not need to carry around a key of a vehicle and can control the unlocking/locking of the door lock of the vehicle by setting the password keyboard. That is, unlocking/locking of the door lock of the vehicle can be achieved at any time, operation is more convenient, and security of the vehicle is further improved.

### CROSS-REFERENCE TO RELATED APPLICATIONS

This application is based upon and claims priority to Chinese Patent Application No. 201510689576.8, titled “keyless password device of locking doors of a vehicle within a short distance and a method of unlocking/locking a vehicle”, filed on Oct. 21, 2015, the entire contents of which are incorporated herein by reference.

### FIELD OF TECHNOLOGY

The present disclosure relates to a field of vehicle technology, and more particularly to a keyless password device of locking doors of a vehicle within a short distance, a vehicle, a vehicle system and a method of unlocking/locking a vehicle.

### BACKGROUND

Automobile lock system is a special component which integrates manufacturability, decorativeness, and security among component systems of cars. A trend of contemporary car lock market requires that car locks have better security and reliability and more functions, and are more coordinating and beautiful to match the integral shape. Since 1970s, intermediate cars have adopted an electrically controlled door-lock of centralized control which generally consists of a main switch of door-lock, a door-lock actuator and a door-lock controller. A centralized control door-lock system of most automobiles installs the main switch of door-lock (center control switch) on the door of the cab, controlling opening and locking of other door-locks by operating this switch. At present there are mainly three ways of unlocking vehicle as follows: mechanical key switch lock; remote key switch lock; and keyless entering system.

Mechanical key unlocking: the method is the most original one. A fundamental principle is inserting a mechanical key into a keyhole position on a car door and rotating the key to achieve opening and locking of the car door.

Remote key unlocking: briefly speaking, an operating principle is that: a key first emits a weak radio wave and a car antenna receives the radio wave signal. After an electronic control unit (ECU) identifies a signal code, a body control management (BCM) drives an actuator (electromotor or solenoid coil) of the system to execute the acts of unlocking/locking. The system mainly consists of a transmitter and a receiver. The transmitter: consists of a transmit switch, a transmitting antenna (a keyboard) and an integrated circuit. The transmitter comprises an identifying code storage loop and an amplitude modulation loop, and is installed with a snapper type lithium battery on a side opposite to the circuit. Transmitting frequency is selected in accordance with a wireless standard of a country that uses it, and the transmit switch transmits a signal every time a snapper is pressed. The receiver: receives the identifying code transmitted by the transmitter via short wave modulation through a short wave antenna of the car, and performs demodulation by using a short wave high frequency amplification processor of a distributor entering into the electronic control unit of the receiver, comparing the code with the identifying code of the demodulator; if the code is correct, it will be inputted into the control circuit to make the actuator work.

The keyless entering system: adopts the most advanced technology of radio frequency identification devices (RFID). A door is locked and unlocked automatically through a reaction of a chip in a smart card carried around by a owner. That is to say, when you walk into a certain distance from a vehicle, the door lock of the vehicle will be opened automatically and close anti-theft mode. When you leave the vehicle, the door lock of the vehicle will be locked automatically and enter into a state of anti-theft. Generally vehicle equipped with the keyless entering system have both a reaction button on a handle of a car door and a keyhole, thus when the smart card is broken or out of power, the owner can open the car door in a common way. When the owner enters into the car, a detecting system in the car will identify the smart car immediately, and after confirmation the computer in the car will enter into a state of working. By now you only need to lightly press a start button or rotary knob in the car, and then the car can start normally. That is to say, whether inside the car or outside the car, the system can guarantee to correctly identify the driver under any circumstances. Intelligent key system is not only convenient, but also helpful for vehicle anti-theft and security.

In practical application scenarios, processes of using the three ways of unlocking vehicle are roughly the same, and a specific steps are as follows:

(1) User carrying a key of a vehicle

A prerequisite of aforesaid way of unlocking a vehicle is that the user must carry around the key of the vehicle. The key will initiatively or passively participate in the vehicle unlocking process in following steps.

(2) The key matching with the vehicle

A matching process for a mechanical key is a process of the key being inserted into the keyhole on the car door.

A matching process for a remote key is: after the user presses the unlocking button, the key of a car firstly emits a weak radio wave and a car antenna receives the radio wave signal; after an electronic control unit indentifying a signal code, passing the identification denoting success of matching.

The matching process for a keyless entering system is: when the user approaches the vehicle with a key, the smart key automatically sending a radio-frequency signal to the vehicle, and a passive entry passive start (PEPS) system of the vehicle receiving the signal and estimating it, passing the estimating denoting success of matching.

(3) Executing unlocking/locking operation

For a mechanical key, rotating the key can complete the unlocking/locking operation.

For a remote key, after the key successfully matches with a vehicle, the body control management drives the actuator (electromotor or solenoid coil) of the system according to the received radio wave command to execute the acts of unlocking/locking.

For a keyless entering system, under the circumstance of successful matching, the user presses a reaction button on the handle of the car door with a finger, and the body control management drives the actuator (electromotor or solenoid coil) of the system to execute the act of unlocking. When the smart key departs from the vehicle with the user for a certain distance, the car antenna cannot receive the radio-frequency signal of the key, and then the body control management automatically drives the actuator of the system to execute the act of locking.

The prerequisite of aforesaid process is that the user must carry around the key of the vehicle. But in practical application process, every owner has the experience of forgetting to carry the key or losing the key of the vehicle. Now in a case of not breaking the lock of the car door, the purpose of opening the car door cannot be reached, not to mention using the vehicle.

### SUMMARY

In view of aforesaid problem, the present disclosure provides a keyless password device of locking doors of a vehicle within a short distance, a vehicle, a vehicle system and a method for unlocking/locking vehicle, so that a user can control unlocking/locking of a car door without the need to carry around a key.

According to one aspect of the present disclosure, a keyless password device of locking doors of a vehicle within a short distance is provided, and the device includes: a password keyboard, a signal processing module, an overall control module, and a door-lock driving module;

wherein the password keyboard generates an analog signal corresponding to at least one key pressed by a user according to the at least one key;

the signal processing module is connected with an output terminal of the password keyboard, and is used for processing the analog signal outputted by the password keyboard to obtain a digital signal;

the overall control module is connected with an output terminal of the signal processing module, and is used for process the digital signal outputted by the signal processing module to obtain key information corresponding to the at least one key, and sending an unlocking/locking operation command to the door-lock driving module according to the key information; and

the door-lock driving module is connected with an output terminal of the overall control module, and is used for controlling opening/locking of a door lock of the vehicle according to the unlocking/locking operation command sent by the overall control module.

According to another aspect of the present disclosure, a vehicle is provided, comprising aforesaid keyless password device of locking doors of a vehicle within a short distance and a vehicle body, and the keyless password device of locking doors of a vehicle within a short distance is installed on the vehicle body.

According to another aspect of the present disclosure, a vehicle system is provided, comprising aforesaid vehicle, a cloud server, and a terminal equipment;

the cloud server is used for fixedly allocating or dynamically allocating an unlocking password; and sending the unlocking password to the vehicle and the terminal equipment;

and

the terminal equipment is used for displaying the unlocking password; for a user to change the unlocking password, and uploading the changed unlocking password to the cloud server via a long-distance communication module.

According to another aspect of the present disclosure, a method of unlocking/locking a vehicle is provided, and the method includes:

receiving an analog signal corresponding to at least one key generated by a user pressing the at least one key of the password keyboard;

processing the analog signal to obtain a digital signal;

processing the digital signal to obtain key information corresponding to the at least one key, and generating an unlocking/locking operation command according to the key information; and

controlling opening/locking of the door lock of the vehicle according to the unlocking/locking operation command.

According to the scheme provided by the present disclosure, after processing an analog signal corresponding to at least one key pressed by a user to obtain key information corresponding to the at least one key, the present disclosure controls unlocking/locking of a door lock of the vehicle according to the key information to achieve that the user does not need to carry around a key of a vehicle and can control the unlocking/locking of the door lock of the vehicle by setting the password keyboard. That is, unlocking/locking of the door lock of the vehicle can be achieved at any time, thus the drawback that the user can only open the vehicle door and enter the vehicle by breaking the door lock of the vehicle when the user forgets to carry the key of the vehicle or the key of the vehicle is lost can be avoided. Operation is more convenient, and security of the vehicle is further improved.

The above illustration is only a general description of the technical solutions provided by the present disclosure, aiming at making the technical means of the present disclosure understood more clearly and thereby practiced based on the contents of the specification. Further, in order to make the above and other objects, features and advantages of the present disclosure more obvious, specific implementations of the present disclosure will be exemplified below.

### BRIEF DESCRIPTION OF THE DRAWINGS

One of ordinary skill in this art will appreciate other advantages from the following detailed description of exemplary embodiments herein. Drawings are only for showing exemplary embodiments but not for limiting the scope of the present disclosure. Through the drawings, similar reference numbers represent similar elements.

FIG. 1 is a structure diagram of a keyless password device of locking doors of a vehicle within a short distance according to an embodiment of the present disclosure;

FIG. 2 is a structure diagram of a keyless password device of locking doors of a vehicle within a short distance according to another embodiment of the present disclosure;

FIG. 3 is a structure diagram of a vehicle according to an embodiment of the present disclosure;

FIG. 4 is a structure diagram of a vehicle system according to an embodiment of the present disclosure;

FIG. 5 is a flowchart showing a method of unlocking/locking a vehicle according to an embodiment of the present disclosure;

FIG. 6 is a flowchart showing a method of unlocking/locking a vehicle according to another embodiment of the present disclosure.

### DESCRIPTION OF THE EMBODIMENTS

Exemplary embodiments of the present disclosure will be described below in detail with reference to drawings. Even though exemplary embodiments of the present disclosure are presented in drawings, it shall be appreciated that the present disclosure may be practiced in various manners without being limited to the embodiments set forth herein. Instead, the embodiments are provided herein to make the present disclosure be understood more thoroughly and to more completely convey the scope of the present disclosure to one of ordinary skill in this art.

FIG. 1 is a structure diagram of a keyless password device of locking doors of a vehicle within a short distance according to an embodiment of the present disclosure. As is shown in FIG. 1, the device 100 includes: a password keyboard 110, a signal processing module 120, an overall control module 130, and a door-lock driving module 140.

Wherein, the password keyboard 110 generates an analog signal corresponding to at least one key pressed by a user according to the at least one key.

The user can control and realize unlocking or locking of a door lock of the vehicle by using the password keyboard, and the door lock of the vehicle in the embodiment of the present disclosure can be a central lock, a trunk lock or a lock of any vehicle door.

The password keyboard of the embodiment of the present disclosure can be set at a position inside a front windshield or a back windshield of a vehicle, and should not affect drivers' sight and be convenient for the user to use the password keyboard. For example, it can be set at the margin of the glass.

After the user presses the at least one key of the password keyboard, the password keyboard can generate an analog signal corresponding to the key according to the key pressed by the user. Each key is corresponding to a different analog signal, thus corresponding key can be identified according to the analog signal.

The signal processing module 120 is connected with an output terminal of the password keyboard 110, and is used for processing the analog signal outputted by the password keyboard to obtain a digital signal.

Specifically, after receiving the analog signal outputted by the password keyboard, the signal processing module 120 performs analog-digital conversion process on the analog signal to convert it into a digital signal. For example, the analog signal can be converted into a digital signal by A/D conversion circuit. After obtaining the digital signal, the signal processing module outputs the digital signal to the overall control module, allowing the overall control module to process.

The overall control module 130 is connected with an output terminal of the signal processing module, and is used for processing the digital signal outputted by the signal processing module to obtain key information corresponding to the at least one key, and sending an unlocking/locking operation command to the door-lock driving module according to the key information.

The key information here can be functions to be realized by the keys, such as unlocking, locking, setting, and the like, or information specifically corresponding to the keys, such as number 1, 2, 3 . . . and so on.

In the embodiment, the user locking the door lock of the vehicle is taken as an example. After the user presses a locking key of the password keyboard, the password keyboard generates an analog signal corresponding to the key, and the signal processing module processes the analog signal to obtain the digital signal corresponding to the key. The overall control module 130 receives the digital signal outputted by the signal processing module 120, and then processes it to obtain the key information corresponding to the key, that is, the key is corresponding to locking, thus it can be known that the user wants to lock the door lock of the vehicle, and then the locking operation command is sent to the door-lock driving module according to the locking information to achieve locking the door lock of the vehicle.

The door-lock driving module 140 is connected with an output terminal of the overall control module, and is used for controlling opening/locking of the door lock of the vehicle according to the unlocking/locking operation command sent by the overall control module.

In aforesaid embodiment, taking the user locking the door lock of the vehicle as an example, after obtaining the key information of locking, the overall control module 130 sends the locking operation command to the door-lock driving module 140. The door-lock driving module 140 controls locking of the door lock of the vehicle according to the locking operation command.

According to the device provided by aforesaid embodiment of the present disclosure, after processing the analog signal corresponding to the at least one key pressed by the user to obtain the key information corresponding to the at least one key, the present disclosure controls unlocking/locking of the door lock of the vehicle according to the key information to achieve that the user does not need to carry around the key of the vehicle and can control the unlocking/locking of the door lock of the vehicle by setting the password keyboard. That is, unlocking/locking of the door lock of the vehicle can be achieved at any time, thus the drawback that the user can only open the vehicle door and enter the vehicle by breaking the door lock of the vehicle when the user forgets to carry the key of the vehicle or the key of the vehicle is lost can be avoided, operation is more convenient, and security of the vehicle is further improved.

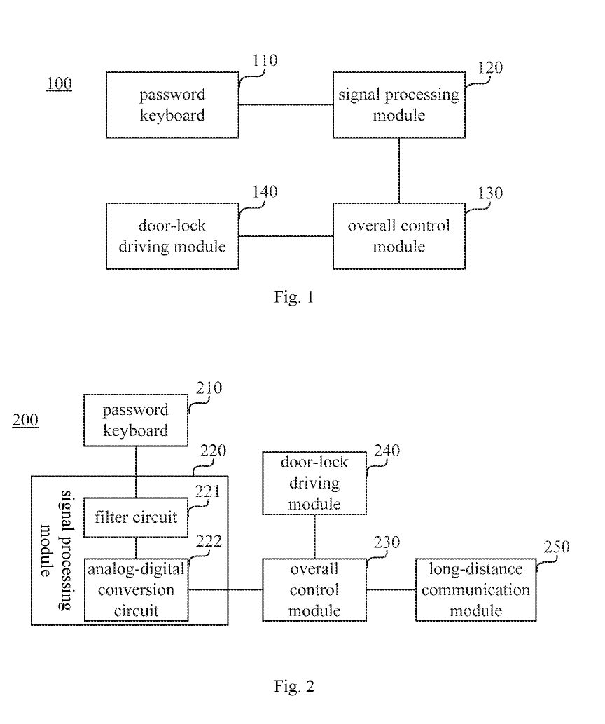

FIG. 2 is a structure diagram of a keyless password device of locking doors of a vehicle within a short distance according to another embodiment of the present disclosure. As is shown in FIG. 2, the device 200 includes: a password keyboard 210, a signal processing module 220, an overall control module 230, a door-lock driving module 240, and a long-distance communication module 250.

Wherein, the password keyboard 210 generates an analog signal corresponding to at least one key pressed by a user according to the at least one key.

In addition, each key in the password keyboard of the embodiment comprises a solenoid coil. The at least one key pressed by the user generates an analog signal corresponding to the key according to magnetic field change of the solenoid coil. Specifically, in the course of the user's finger approaching the key and pressing the corresponding key of the password keyboard, the magnetic field around the solenoid coil contained by the key will change, and the key will emit the corresponding analog signal.

Specifically, the password keyboard 210 includes: an unlocking key, a locking key, at least one indicator light, numeral keys and a setting key; wherein the at least one indicator light is for indicating a successful/failed unlocking/locking.

Preferably, the password keyboard of the embodiment includes: one unlocking key, one locking key, one green light, one red light, one setting key, and numeral keys of 0˜5 or 0˜6 or 0˜7 or 0˜8 or 0˜9. The number of the numeral keys herein is set according to need or size of the password keyboard. When the user needs to open the lock, the user presses the unlocking password successively referring to the numeral keys, and then presses the unlocking key to achieve unlocking. If unlocking succeeds, the green light flickers to prompt successful unlocking; if unlocking fails, the red light flickers to prompt failed unlocking. When the user needs to lock the car, the user directly presses the locking key to achieve locking. If locking succeeds, the green light flickers to prompt successful locking; if locking fails, the red light flickers to prompt failed locking.

Optionally, the present disclosure can indicate successful/failed unlocking/locking by one indicator light. The indicator light can prompt successful/failed unlocking/locking by changing colors of flickering. The specific implementation is as follows: if unlocking succeeds, the indicator light is displayed as green to prompt successful unlocking; if unlocking fails, the indicator light is displayed as red to prompt failed unlocking; if locking succeeds, the indicator light is displayed as green to prompt successful locking; if locking fails, the indicator light is displayed as red to prompt failed locking.

The setting key in the embodiment is for the user to change unlocking password. When the user needs to change the unlocking password, he/she can press the setting key to get in a password setting mode, prompting the user to input the password before changing and the password after changing, and then the user presses the setting key again to complete changing the unlocking password.

In case the user forgets the unlocking password and cannot control the door lock of the vehicle, after the user changes the unlocking password, the long-distance communication module can upload the changed unlocking password to a cloud server for storing. When the user forgets the unlocking password, the unlocking password stored in the cloud server can be acquired via a terminal equipment such as a mobile phone.

The signal processing module 220 is connected with an output terminal of the password keyboard 210, and is used for processing the analog signal outputted by the password keyboard to obtain a digital signal.

Wherein, the signal processing module includes: a filter circuit 221 and an analog-digital conversion circuit 222.

The filter circuit 221 is connected with an output terminal of the password keyboard, and is used for filtering the analog signal outputted by the password keyboard.

Specifically, the filter circuit 221 can be a band-pass filter circuit, which just allows signals within a frequency band to pass, and signals outside the frequency band cannot pass. The filter circuit receives the analog signal outputted by the password keyboard, and then filters clutter of very high frequency and very low frequency in the analog signal to retain the analog signal corresponding to the key pressed by the user, so that noise interference can be eliminated and the overall control module can more accurately obtain key information corresponding to the key pressed by the user's finger. Wherein, the band-pass frequency is set according to practical situation.

The analog-digital conversion circuit 222 is connected with an output terminal of the filter circuit 221, and is used for converting a filtered analog signal into a digital signal.

The filter circuit 221 performs filtering process on the analog signal and outputs a signal after filtering process to the analog-digital conversion circuit 222, and the analog-digital conversion circuit 222 converts the analog signal into a digital signal.

The overall control module 230 is connected with an output terminal of the signal processing module, and is used for processing the digital signal outputted by the signal processing module to obtain key information corresponding to at least one key, and sending an unlocking/locking operation command to the door-lock driving module according to the key information.

The key information herein can be functions to be realized by the keys, such as unlocking, locking, setting, and the like, or information specifically corresponding to the keys, such as number 1, 2, 3 . . . and so on.

In the embodiment, the user locking the door lock of the vehicle is taken as an example. After the user presses a locking key of the password keyboard 210, the password keyboard 210 generates an analog signal corresponding to the key, and the signal processing module 220 processes the analog signal to obtain the digital signal corresponding to the key. The overall control module 230 receives the digital signal outputted by the signal processing module 220, and then processes it to obtain the key information corresponding to the key, that is, the key is corresponding to locking, thus it can be known that the user wants to locking the door lock of the vehicle, and then a locking operation command is sent to the door-lock driving module 240 according to the locking information to achieve locking of the door lock of the vehicle.

In the embodiment of the present disclosure, the long-distance communication module 250 is preferably a wireless communication module. 2G or 3G or 4G or other communication modes can be adopted to realize information interaction with the cloud server.

The unlocking password in the embodiment of the present disclosure not only can be set freely by the user via the setting key provided by the password keyboard, but further can be fixedly allocated or dynamically allocated by the cloud server. After allocation, the user is informed by text messages, phone calls, APP, etc. In addition, the user can set or change the password by means of text messages, phone calls, APP, etc. In use, the cloud server sends the unlocking password to the overall control module via the long-distance communication module.

In order to further improve security of the vehicle, the embodiment of the present disclosure further adopts a way of sending the unlocking password to the user's terminal equipment and the overall control module by the cloud server. The user inputs the password via the password keyboard according to the unlocking password sent by the cloud server. Opening/locking of the door lock of the vehicle can be realized by comparing whether or not the password inputted by the user and the unlocking password received by the overall control module are the same, and a specific implementation is as follows:

If an inputted password is pressed via the password keyboard by the user, for example, pressing corresponding numeral keys and the unlocking key to confirm that the user inputs the corresponding password, the overall control module is further used for receiving the unlocking password sent by the cloud server via the long-distance communication module, comparing whether or not the inputted password is in accordance with the unlocking password, and sending the unlocking operation command to the door-lock driving module according to a comparing result.

Specifically, when the inputted password is in accordance with the unlocking password, the overall control module sends the unlocking operation command to the door-lock driving module; when the inputted password is not in accordance with the unlocking password, the overall control module does not perform any operation, that is, not sending any operation command to the door-lock driving module, affirming the failure of unlocking, and uploading the failure information to the cloud server via the long-distance communication module.

If a locking key is pressed via the password keyboard by the user, the overall control module 230 processes the digital signal outputted by the signal processing module to obtain the key information corresponding to the locking key, and sends the locking operation command to the door-lock driving module according to the key information.

The door-lock driving module 240 is connected with an output terminal of the overall control module, and is used for controlling opening/locking of the door lock of the vehicle according to the unlocking/locking operation command sent by the overall control module.

In the case of the overall control module 230 sending an unlocking operation command to the door-lock driving module 240, the door-lock driving module 240 controls the door lock of the vehicle to be opened according to a received unlocking operation command;

In the case of the overall control module 230 sending a locking operation command to the door-lock driving module 240, the door-lock driving module 240 controls the door lock of the vehicle to be locked according to a received locking operation command.

The door-lock driving module 240 controls the unlocking/locking of the door lock of the vehicle, and then further feeds back status information of the door lock of the vehicle to the overall control module 230. The status information of the door lock of the vehicle refers to the door lock of the vehicle in an unlocking state or in a locking state.

The overall control module 230 is further used for: receiving the status information of the door lock of the vehicle fed back by the door-lock driving module 240 and uploading the status information of the door lock of the vehicle, a unlocking/locking operation and timestamp of the unlocking/locking operation to the cloud server via the long-distance communication module 250, so that the cloud server can comprehensively monitor the device, i.e. the vehicle.

In addition, the overall control module 230 receives the status information of the door lock of the vehicle, and then further send a command of controlling at least one indicator light of the password keyboard to flicker to the signal processing module 220 according to the status information of the door lock of the vehicle;

The signal processing module 220 is further used for: processing the command and controlling at least one indicator light of the password keyboard to flicker.

Specifically, when the overall control module sends an unlocking operation command to the door-lock driving module, and the status information of the door lock of the vehicle fed back by the door-lock driving module is the door lock of the vehicle in a state of opening, the overall control module sends the command to control the green light of the password keyboard to flicker to the signal processing module according to the status information of the door lock of the vehicle. The signal processing module processes the command, and controls the green light of the password keyboard to flicker, thus the user is prompted that unlocking is successful.

When the overall control module sends a locking operation command to the door-lock driving module, and the status information of the door lock of the vehicle fed back by the door-lock driving module is the door lock of the vehicle in a state of locking, the overall control module sends the command to control the green light of the password keyboard to flicker to the signal processing module according to the status information of the door lock of the vehicle. The signal processing module processes the command, and controls the green light of the password keyboard to flicker, thus the user is prompted that locking is successful.

Furthermore, when the password inputted by the user is not in accordance with the unlocking password sent by the cloud server to the overall control module, the overall control module identifies this operation as a failure, and sends a command of controlling the red light of the password keyboard to flicker to the signal processing module. The signal processing module processes the command, and controls the red light of the password keyboard to flicker, thus the user is prompted that unlocking is failed.

If the overall control module sends a locking operation command to the door-lock driving module, the status information of the door lock of the vehicle fed back by the door-lock driving module is the door lock of the vehicle in a state of opening, and the overall control module identifies this operation as a failure, and sends a command of controlling the red light of the password keyboard to flicker to the signal processing module. The signal processing module processes the command, and controls the red light of the password keyboard to flicker, thus the user is prompted that locking is failed.

Optionally, the signal processing module can further include an digital-analog conversion circuit, is used for converting the command to control at least one indicator light of the password keyboard to flicker sent by the overall control module from digital signal into analog signal, and controlling flicker of at least one indicator light.

Optionally, the door-lock driving module is a controller area network node driving circuit, is used for sending door-lock opening/locking command to a CAN bus of the vehicle according to the unlocking/locking operation command sent by the overall control module; and collecting status information of the door lock of the vehicle from the CAN bus.

Optionally, the door-lock driving module is a high-power rigid line driving circuit, is used for driving an actuator corresponding to the door lock of the vehicle to perform door-lock unlocking/locking operation, and feeding back the operation result of the actuator to the overall control module.

According to the device provided by aforesaid embodiment of the present disclosure, after processing an analog signal corresponding to at least one key pressed by a user to obtain key information corresponding to at least one key, the present disclosure controls unlocking/locking of the door-lock according to the key information to achieve that the user does not need to carry around the key of the vehicle and can control the unlocking/locking of the door lock of the vehicle by setting the password keyboard. That is, unlocking/locking of the door lock of the vehicle can be achieved at any time, thus the drawback that the user can only open the vehicle door and enter the vehicle by breaking the door lock of the vehicle when the user forgets to carry the key of the vehicle or the key of the vehicle is lost can be avoided. Operation is more convenient. The password is allocated in the cloud server, and the cloud server sends the unlocking password via the long-distance communication module and compares the password inputted by the user and the unlocking password, thus setting a user right. Only when the user has the right, the door lock of the vehicle can be opened, thus security of the vehicle is further improved; by uploading the status information of the door lock of the vehicle, the unlocking/locking operation and timestamp of the unlocking/locking operation to the cloud server, the cloud server can comprehensively monitor the device and the vehicle, thus security is further upgraded.

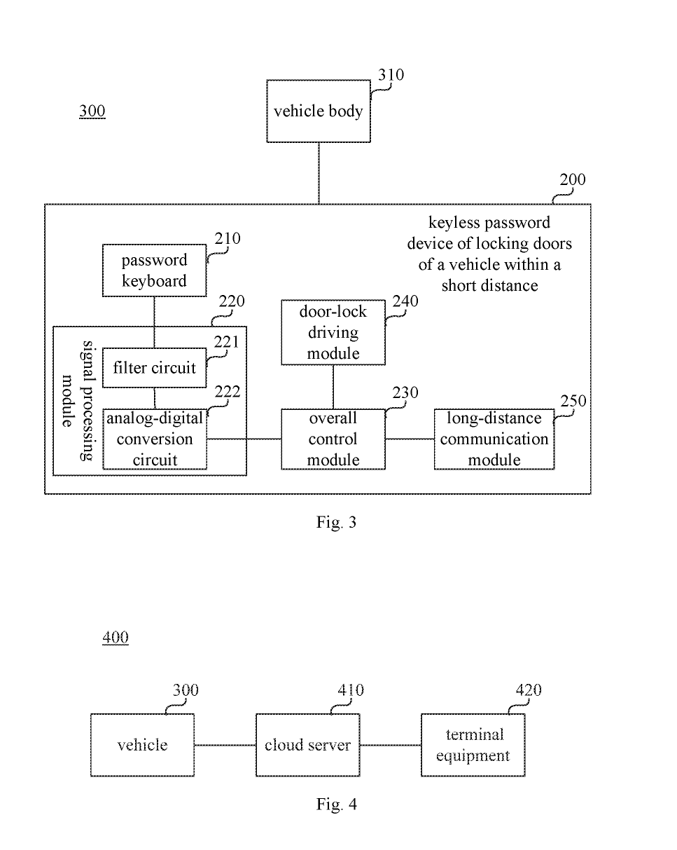

FIG. 3 is a structure diagram of a vehicle according to an embodiment of the present disclosure. As is shown in FIG. 3, the vehicle includes: a keyless password device of locking doors of a vehicle within a short distance 200 and a vehicle body 310.

Wherein, the keyless password device of locking doors of a vehicle within a short distance is installed on the vehicle body.

Optionally, the password keyboard is set at a position inside a front windshield or a back windshield of the vehicle body, wherein the position of the password keyboard should not affect drivers' sight and be convenient for the user to use the password keyboard. For example, it can be set at the margin of the glass.

According to the vehicle provided by aforesaid embodiment of the present disclosure, after processing an analog signal corresponding to at least one key pressed by a user to obtain the key information corresponding to the at least one key, the present disclosure controls unlocking/locking of a door-lock according to the key information to achieve that the user does not need to carry around the key of the vehicle and can control the unlocking/locking of the door lock of the vehicle by setting the password keyboard. That is, unlocking/locking of the door lock of the vehicle can be achieved at any time, thus the drawback that the user can only open the vehicle door and enter the vehicle by breaking the door lock of the vehicle when the user forgets to carry the key of the vehicle or the key of the vehicle is lost can be avoided. Operation is more convenient, and security of the vehicle is further improved.

FIG. 4 is a structure diagram of a vehicle system according to an embodiment of the present disclosure. As is shown in FIG. 4, the vehicle system includes: a vehicle 300, a cloud server 410 and a terminal equipment 420.

The cloud server 410 is used for fixedly allocating or dynamically allocating unlocking password; and sending the unlocking password to the vehicle and the terminal equipment.

The terminal equipment 420 is used for displaying the unlocking password; for a user to change the unlocking password, and uploading the changed unlocking password to the cloud server via a long-distance communication module.

Specifically, after the password is allocated fixedly or dynamically by the cloud server, the user is informed through text messages, phone calls, APP, etc. In addition, the user can set or change the password by means of text messages, phone calls, APP, etc. In use, the cloud server sends the unlocking password to the vehicle 300.

According to the system provided by aforesaid embodiment of the present disclosure, after processing an analog signal corresponding to at least one key pressed by a user to obtain key information corresponding to the at least one key, the present disclosure controls unlocking/locking of the door-lock according to the key information to achieve that the user does not need to carry around a key of a vehicle and can control the unlocking/locking of the door lock of the vehicle by setting the password keyboard. That is, unlocking/locking of the door lock of the vehicle can be achieved at any time, thus the drawback that the user can only open the vehicle door and enter the vehicle by breaking the door lock of the vehicle when the user forgets to carry the key of the vehicle or the key of the vehicle is lost can be avoided. Operation is more convenient. The password is allocated in the cloud server, and the cloud server sends the unlocking password via the long-distance communication module and compares the password inputted by the user and the unlocking password, thus setting a user right. Only when the user has the right, the door lock of the vehicle can be opened, thus security of the vehicle is further improved; by uploading the status information of the door lock of the vehicle, the unlocking/locking operation and timestamp of the unlocking/locking operation to the cloud server, the cloud server can comprehensively monitor the device and the vehicle, thus security is further upgraded.

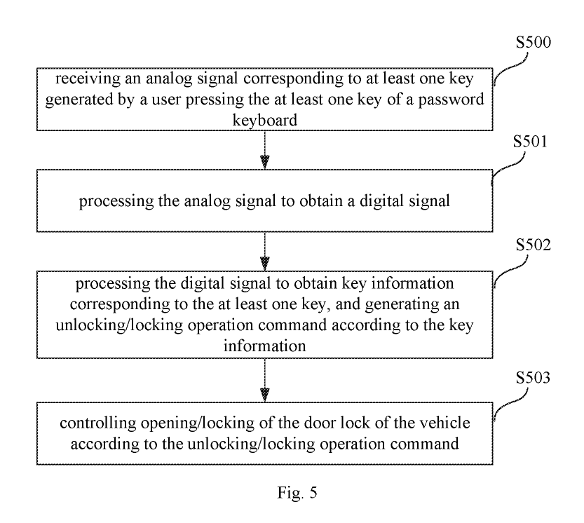

FIG. 5 is a flowchart showing a method of unlocking/locking a vehicle according to an embodiment of the present disclosure. As is shown in FIG. 5, the method includes the following steps:

Step S500, receiving an analog signal corresponding to at least one key generated by a user pressing the at least one key of a password keyboard.

After the user presses the at least one key of the password keyboard, the password keyboard can generate an analog signal corresponding to the key according to the key pressed by the user. Each key is corresponding to a different analog signal, thus corresponding key can be identified according to the analog signal.

Step S501, processing the analog signal to obtain a digital signal.

Specifically, a signal processing module processes the analog signal. The signal processing module receives the analog signal outputted by the password keyboard, and then performs analog-digital conversion process on the analog signal to convert it into a digital signal. For example, the analog signal can be converted into the digital signal by A/D conversion circuit. After obtaining the digital signal, the signal processing module outputs the digital signal to the overall control module, allowing the overall control module to process.

Step S502, processing the digital signal to obtain key information corresponding to the at least one key, and generating an unlocking/locking operation command according to the key information.

The key information herein can be functions to be realized by the keys, such as unlocking, locking, setting, and the like, or information specifically corresponding to the keys, such as number 1, 2, 3 . . . and so on.

In the embodiment, the user locking the door lock of the vehicle is taken as an example. After the user presses a locking key of the password keyboard, the password keyboard generates an analog signal corresponding to the key, and the signal processing module processes the analog signal to obtain the digital signal corresponding to the key. The overall control module receives the digital signal outputted by the signal processing module, and then processes it to obtain the key information corresponding to the key, that is, the key is corresponding to locking, thus it can be known that the user wants to locking the door lock of the vehicle, and then a locking operation command is sent to the door-lock driving module according to the locking information to achieve locking of the door lock of the vehicle.

Step S503, controlling opening/locking of the door lock of the vehicle according to the unlocking/locking operation command.

In aforesaid embodiment, taking the user locking the door lock of the vehicle as an example, after obtaining the key information of locking, the overall control module sends the locking operation command to the door-lock driving module. The door-lock driving module controls the locking of the door lock of the vehicle according to the locking operation command.

According to the method provided by aforesaid embodiment of the present disclosure, after processing the analog signal corresponding to the at least one key pressed by the user to obtain key information corresponding to the at least one key, the present disclosure control unlocking/locking of the door-lock according to the key information to achieve that the user does not need to carry around a key of a vehicle and can control the unlocking/locking of the door lock of the vehicle by setting the password keyboard. That is, unlocking/locking of the door lock of the vehicle can be achieved at any time, thus the drawback that the user can only open the vehicle door and enter the vehicle by breaking the door lock of the vehicle when the user forgets to carry the key of the vehicle or the key of the vehicle is lost can be avoided. Operation is more convenient, and security of the vehicle is further improved.

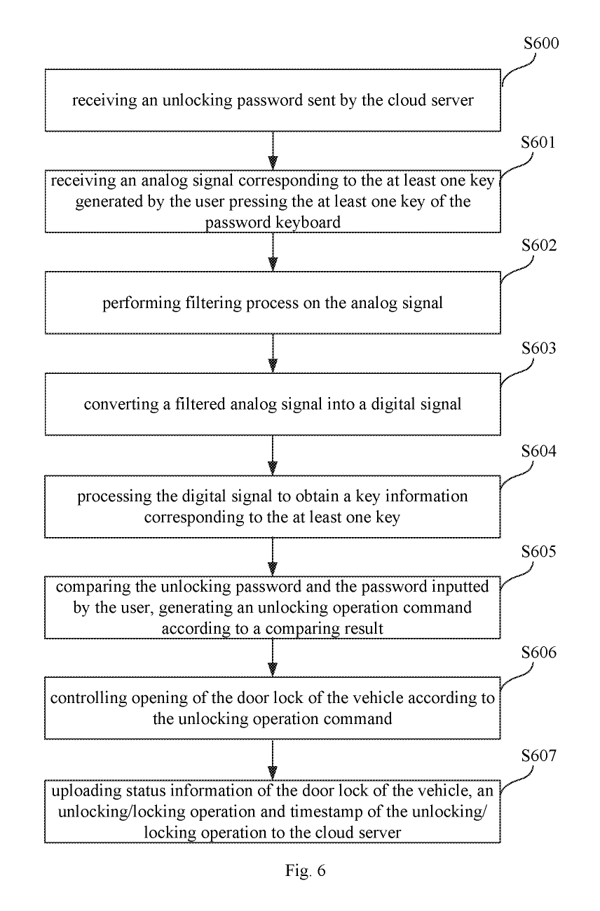

FIG. 6 is a flowchart showing a method of unlocking/locking a vehicle according to another embodiment of the present disclosure. As is shown in FIG. 6, the method includes the following steps:

Step S600, receiving an unlocking password sent by the cloud server.

In order to further improve security of the vehicle, the embodiment of the present disclosure further adopts a way of sending the unlocking password to the user's terminal equipment and the overall control module by the cloud server. The user inputs the password via the password keyboard according to the unlocking password sent by the cloud server. Opening of the door lock of the vehicle can be realized by comparing whether or not the password inputted by the user and the unlocking password received by the overall control module are the same.

Specifically, the unlocking password can be allocated fixedly or dynamically by the cloud server. After configuration, the user is informed through text messages, phone calls, APP, etc. In addition, the user can set or change the password by means of text messages, phone calls, APP, etc. In use, the cloud server sends the unlocking password to the overall control module via the long-distance communication module.

Step S601, receiving an analog signal corresponding to the at least one key generated by the user pressing the at least one key of the password keyboard.

Step S602, performing filtering process on the analog signal.

Specifically, the analog signal is filtered via a filter circuit. The filter circuit can be a band-pass filter circuit, which just allows signals within a frequency band to pass, and signals outside the frequency band cannot pass. The filter circuit receives the analog signal outputted by the password keyboard, and then filters clutter of very high frequency and very low frequency in the analog signal to retain the analog signal corresponding to the key pressed by the user, so that noise interference can be eliminated and the overall control module can more accurately obtain key information corresponding to the key pressed by the user's finger. Wherein, the band-pass frequency is set according to practical situation.

Step S603, converting a filtered analog signal into a digital signal.

Specifically, the filtered analog signal is converted into the digital signal by the analog-digital conversion circuit, wherein the analog-digital conversion circuit can be an A/D conversion circuit.

Step S604, processing the digital signal to obtain a key information corresponding to the at least one key.

The key information herein can be functions to be realized by the keys, such as unlocking, locking, setting, and the like, or information specifically corresponding to the keys, such as number 1, 2, 3 . . . and so on.

Step S605, comparing the unlocking password and the password inputted by the user, generating an unlocking operation command according to a comparing result.

Specifically, when the inputted password is in accordance with the unlocking password, the overall control module sends the unlocking operation command to the door-lock driving module; when the inputted password is not in accordance with the unlocking password, the overall control module does not perform any operation, that is, not sending any operation command to the door-lock driving module, affirming a failure of unlocking, and uploading the failure information to the cloud server via the long-distance communication module.

If the user presses the locking key via the password keyboard, process the digital signal to obtain the key information corresponding to the locking key, and send locking operation command according to the key information. Specifically, the overall control module processes the digital signal outputted by the signal processing module to obtain the key information corresponding to the locking key, and sends locking operation command to the door-lock driving module according to the key information.

Step S606, controlling opening of the door lock of the vehicle according to the unlocking operation command.

The door-lock driving module controls opening/locking the door lock of the vehicle according to the unlocking/locking operation command sent by the overall control module. Specifically, in the case of the overall control module sending the unlocking operation command to the door-lock driving module, the door-lock driving module controls the door lock of the vehicle to be opened according to a received unlocking operation command;

In the case of the overall control module sending the locking operation command to the door-lock driving module, the door-lock driving module controls the door lock of the vehicle to be locked according to a received locking operation command.

Step S607, uploading status information of the door lock of the vehicle, an unlocking/locking operation and timestamp of the unlocking/locking operation to the cloud server.

The status information of the door lock of the vehicle, the unlocking/locking operation and timestamp of the unlocking/locking operation is for the cloud server to comprehensively monitor the vehicle, improving security of the vehicle.

Optionally, the method further includes: controlling at least one indicator light of the password keyboard to flicker according to the status information of the door lock of the vehicle.

Specifically, the overall control module receives the status information of the door lock of the vehicle, and then further sends a command of controlling at least one indicator light of the password keyboard to flicker to the signal processing module according to the status information of the door lock of the vehicle;

The signal processing module is further used for: processing the command, and controlling at least one indicator light of the password keyboard to flicker.

Specifically, when the overall control module sends an unlocking operation command to the door-lock driving module, the status information of the door lock of the vehicle fed back by the door-lock driving module is a door lock of the vehicle in a state of opening, and the overall control module sends the command to control the green light of the password keyboard to flicker to the signal processing module according to the status information of the door lock of the vehicle. The signal processing module processes the command, and controls the green light of the password keyboard to flicker, thus the user is prompted that unlocking is successful.

When the overall control module sends a locking operation command to the door-lock driving module, the status information of the door lock of the vehicle fed back by the door-lock driving module is the door lock of the vehicle in a state of locking, and the overall control module sends the command to control the green light of the password keyboard to flicker to the signal processing module according to the status information of the door lock of the vehicle. The signal processing module processes the command, and controls the green light of the password keyboard to flicker, thus the user is prompted that locking is successful.

Furthermore, when the password inputted by the user is not in accordance with the unlocking password sent by the cloud server to the overall control module, the overall control module identifies this operation as a failure, and sends a command of controlling the red light of the password keyboard to flicker to the signal processing module. The signal processing module processes the command, and controls the red light of the password keyboard to flicker, thus the user is prompted that unlocking is failed.

If the overall control module sends a locking operation command to the door-lock driving module, the status information of the door lock of the vehicle fed back by the door-lock driving module is the door lock of the vehicle in a state of opening, and the overall control module identifies this operation as a failure, and sends a command of controlling the red light of the password keyboard to flicker to the signal processing module. The signal processing module processes the command, and controls the red light of the password keyboard to flicker, thus the user is prompted that locking is failed.

Optionally, controlling opening/locking of the door lock of the vehicle according to the unlocking/locking operation command further includes: sending door-lock opening/locking command to a CAN bus of the vehicle to control opening/locking of the door lock of the vehicle.

The method further includes: collecting the status information of the door lock of the vehicle from the CAN bus.

Optionally, said controlling opening/locking of the door lock of the vehicle according to the unlocking/locking operation command further includes: driving an actuator corresponding to the door lock of the vehicle to opening/locking the door lock of the vehicle.

The method further includes: uploading an executing result of the actuator to the cloud server.

According to the method provided by aforesaid embodiment of the present disclosure, after processing an analog signal corresponding to at least one key pressed by a user to obtain the key information corresponding to the at least one key, the present disclosure controls unlocking/locking of a door lock of the vehicle according to the key information to achieve that the user does not need to carry around the key of the vehicle and can control the unlocking/locking of the door lock of the vehicle by setting the password keyboard. That is, unlocking/locking of the door lock of the vehicle can be achieved at any time, thus the drawback that the user can only open the vehicle door and enter the vehicle by breaking the door lock of the vehicle when the user forgets to carry the key of the vehicle or the key of the vehicle is lost can be avoided. Operation is more convenient. The password is allocated in the cloud server, and the cloud server sends the unlocking password via the long-distance communication module and compares the password inputted by the user and the unlocking password, thus setting a user right. Only when the user has the right, the door lock of the vehicle can be opened, thus security of the vehicle is further improved; by uploading the status information of the door lock of the vehicle, unlocking/locking operation and timestamp of the unlocking/locking operation to the cloud server, the cloud server can comprehensively monitor the device and the vehicle, thus security is further upgraded.

The above description has presented and illustrated many exemplary embodiments of the present disclosure, and however, as stated above, it shall be appreciated that the present disclosure is not limited to the implementations disclosed herein, providing these exemplary embodiments shall not be deemed as excluding other embodiments. Instead, the technical solutions in the present disclosure may be applied in any other combinations, variations and environments, and may be modified based on the above teaching or technologies or knowledge in related fields within the conceiving scope of the present disclosure. Any modifications or changes performed by one of ordinary skill in this art without departing from the spirit and scope of the present disclosure shall fall within the protection scope as defined by appended claims.

1. A keyless password device of locking doors of a vehicle within a short distance, wherein the device comprises: a password keyboard, a signal processing module, an overall control module, and a door-lock driving module;
wherein said password keyboard generates an analog signal corresponding to at least one key pressed by a user according to the at least one key;
wherein said signal processing module is connected with an output terminal of said password keyboard, and is used for processing the analog signal outputted by said password keyboard to obtain a digital signal;
wherein said overall control module is connected with an output terminal of said signal processing module, and is used for processing the digital signal outputted by said signal processing module to obtain key information corresponding to the at least one key, and sending an unlocking/locking operation command to said door-lock driving module according to said key information; and
wherein said door-lock driving module is connected with an output terminal of said overall control module, and is used for controlling opening/locking of a door lock of the vehicle according to the unlocking/locking operation command sent by said overall control module.

2. The device according to claim 1, wherein the device further comprises: a long-distance communication module;
if an inputted password is pressed via the password keyboard by the user, said overall control module is further used for: receiving an unlocking password sent by a cloud server via said long-distance communication module, and comparing whether or not the inputted password is in accordance with the unlocking password, and sending an unlocking operation command to said door-lock driving module according to the comparing result.

3. The device according to claim 1, wherein if a locking key is pressed via said password keyboard by the user, said overall control module is further used for: processing the digital signal outputted by said signal processing module to obtain key information corresponding to the locking key, and sending a locking operation command to said door-lock driving module according to said key information.

4. The device according to claim 2, wherein said door-lock driving module is further used for feeding back status information of the door lock of the vehicle to said overall control module; and
wherein said overall control module is further used for: receiving the status information of the door lock of the vehicle fed back by said door-lock driving module and uploading the status information of the door lock of the vehicle, the unlocking/locking operation and timestamp of the unlocking/locking operation to a cloud server via said long-distance communication module.

5. The device according to claim 2, wherein said long-distance communication module is a wireless communication module.

6. The device according to claim 1, wherein said password keyboard comprises: an unlocking key, a locking key, at least one indicator light, numeral keys and a setting key; and
wherein the at least one indicator light is used for indicating a successful/failed unlocking/locking.

7. The device according to claim 6, wherein each key in said password keyboard comprises a solenoid coil, and the at least one key pressed by the user generates the analog signal corresponding to the key according to magnetic field change of the solenoid coil.

8. The device according to claim 6, wherein said overall control module is further used for: sending a command of controlling the at least one indicator light of said password keyboard to flicker to said signal processing module according to said status information of the door lock of the vehicle; and
wherein said signal processing module is further used for: processing said command and controlling the at least one indicator light of said password keyboard to flicker.

9. The device according to claim 1, wherein said signal processing module comprises: a filter circuit and an analog-digital conversion circuit;
wherein said filter circuit is connected with an output terminal of said password keyboard, and is used for filtering the analog signal outputted by said password keyboard; and
wherein said analog-digital conversion circuit is connected with an output terminal of said filter circuit, and is used for converting the filtered analog signal into a digital signal.

10. The device according to claim 1, wherein said door-lock driving module is a controller area-network-node driving circuit, and is used for sending a door-lock opening/locking command to a CAN bus of the vehicle according to the unlocking/locking operation command sent by said overall control module; and collecting status information of the door lock of the vehicle from said CAN bus.

11. The device according to claim 1, wherein said door-lock driving module is a high-power rigid line driving circuit, and is used for driving an actuator corresponding to the door lock of the vehicle to perform door-lock unlocking/locking operations, and feeding back the operation result of said actuator to said overall control module.

12. A vehicle, comprising the keyless password device of locking doors of a vehicle within a short distance according to claim 1 and a vehicle body, said keyless password device of locking doors of a vehicle within a short distance is installed on said vehicle body.

13. The vehicle according to claim 12, wherein said password keyboard is set at a position inside a front windshield or a back windshield of said vehicle body.

14. A vehicle system, comprising a vehicle according to claim 12, a cloud server, and a terminal equipment;
wherein said cloud server is used for fixedly allocating or dynamically allocating an unlocking password; and to send the unlocking password to said vehicle and said terminal equipment; and
wherein said terminal equipment is used for displaying said unlocking password so as to make the unlocking password changed by a user, and uploading the changed unlocking password to said cloud server via a long-distance communication module.

15. A method of unlocking/locking a vehicle, wherein the method comprises:
receiving an analog signal corresponding to at least one key generated by a user pressing the at least one key of the password keyboard;
processing said analog signal to obtain a digital signal;
processing said digital signal to obtain key information corresponding to the at least one key, and generating an unlocking/locking operation command according to said key information; and
controlling opening/locking of a door lock of the vehicle according to said unlocking/locking operation command.

16. The method according to claim 15, wherein said method further comprises: receiving an unlocking password sent by a cloud server; and
wherein said controlling opening/locking of the door lock of the vehicle according to said unlocking/locking operation command further comprises: comparing said unlocking password with an inputted password pressed by the user, and generating the unlocking operation command according to a comparing result.

17. The method according to claim 15, wherein said processing said digital signal to obtain key information corresponding to the at least one key, and generating an unlocking/locking operation command according to said key information further comprises:
processing said digital signal to obtain key information corresponding to a locking key, and generating the locking operation command according to said key information.

18. The method according to claim 16, wherein said method further comprises:
uploading status information of the door lock of the vehicle, the unlocking/locking operation and timestamp of the unlocking/locking operation to a cloud server.

19. The method according to claim 18, wherein said method further comprises:
controlling at least one indicator light of the password keyboard to flicker according to said status information of the door lock of the vehicle.

20. The method according to claim 15, wherein said processing said analog signal to obtain a digital signal further comprises:
performing filtering process on said analog signal; and
converting a filtered analog signal into the digital signal.

21. The method according to claim 15, wherein said controlling opening/locking of the door lock of the vehicle according to said unlocking/locking operation command further comprises: sending said unlocking/locking operation command to a CAN bus of the vehicle to control the opening/locking of the door lock of the vehicle; and
wherein said method further comprises: collecting the status information of the door lock of the vehicle from said CAN bus.

22. The method according to claim 15, wherein said controlling opening/locking of the door lock of the vehicle according to said unlocking/locking operation command further comprises: driving an actuator corresponding to the door lock of the vehicle to open/lock the door lock of the vehicle; and
wherein said method further comprises: uploading an executing result of said actuator to the cloud server.
